(19) United States
(12) Patent Application Publication
(10) Pub. No.: US 2026/0135309 A1
(43) Pub. Date: May 14, 2026

(54) ISOLATED DIFFERENTIAL HIGH-SPEED INTERPOSER

(71) Applicant: Raytheon Company, Tewksbury, MA (US)

(72) Inventors: Ara Nazari, Agoura Hills, CA (US); Ryan G. Conolley, Goleta, CA (US); Salvatore Bentivenga, Ellicott City, MD (US); Phuong Nguyen, Gardena, CA (US); Jesse Butler, Santa Barbara, CA (US)

(21) Appl. No.: 18/945,003

(22) Filed: Nov. 12, 2024

(51) Int. Cl. H01R 12/71; H01R 13/24

(52) U.S. Cl. CPC H01R 12/714; H01R 13/2407

(57) ABSTRACT

Circuitry and a method are described for enabling high-frequency differential signal transmission up to at least about 40 GHz. Electronic components are separated by an interposer. The interposer includes a conductive housing. Non-conductive inserts are disposed within the conductive housing and pairs of differential spring probes are disposed in each of the inserts. Each pair of spring probes is configured to couple differential signals between the electronic components at frequencies up to at least about 40 GHz. A conductive gasket is disposed on a surface of the conductive housing to provide a ground connection between the electronic components and provide a continuous ground around the pairs of spring probes.

### GOVERNMENTAL RIGHTS

This invention was made with government support. The government has certain rights in the invention.

### TECHNICAL FIELD

The present subject matter relates generally to interposers and more specifically to an interposer to carry differential signals.

### BACKGROUND

Interposers are specialized electronic components used to connect different circuit boards or electronic modules, particularly in high-frequency applications. They serve as an interface between two boards, allowing for electrical connections while addressing challenges such as signal integrity, isolation, and space constraints. However, tight spacing and lack of radio frequency (RF) shielding around differential pairs makes isolation, especially at higher frequencies, a challenge when using an interposer.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates an exploded view of an interposer according to some embodiments.

FIG. 1B illustrates a top view of the interposer of FIG. 1A.

FIG. 1C illustrates a side view of the interposer of FIG. 1A.

FIG. 1D illustrates a bottom view of the interposer of FIG. 1A.

FIG. 1E illustrates a cross-sectional view of the interposer of FIG. 1C.

FIG. 1F illustrates a cross-sectional view of the interposer of FIG. 1A.

FIG. 2 illustrates a system according to some embodiments.

FIG. 3 shows a method of fabricating an interposer according to some embodiments.

FIG. 4 illustrates a block diagram of an electronic device in accordance with some aspects.

### DETAILED DESCRIPTION

As above, connecting modular RF personality boards (RFPBs) in high-frequency performance applications of up to 40 GHz, and greater, may use interposers. Interposers are specialized electronic components that serve as intermediaries between different circuit boards or electronic modules. However, interposer design may be difficult, especially for high frequency and high connection density applications. Tight spacing requirements and lack of RF shielding around differential pairs makes isolation at higher frequencies challenging. This is notably true when ground pins are used to surround signals, as the ground pins are discrete points that allow energy to leak and provide limited isolation. The interposers herein are designed to take up minimal space while minimizing RF routing issues. These interposers use spring probes, also known as pogo pins. The spring probes provide a flexible and reliable connection between boards and are capable of maintaining electrical contact across a range of board-to-board spacings, thereby permitting connection.

One challenge in interposer design is maintaining signal integrity and isolation between differential pairs, especially at higher frequencies and throughout an extended frequency range as typically one or more reductions in return loss and isolation occur over the operational frequency range. To address this, as described herein, pogo pins are pressed into a non-conductive material, which is then integrated in a housing. An electrically conductive gasket may be used to provide a continuous ground connection between differential pair signals. This combined structure may improve isolation in high-frequency (and other) applications and complex electronic systems where direct connections between components may be challenging or impractical.

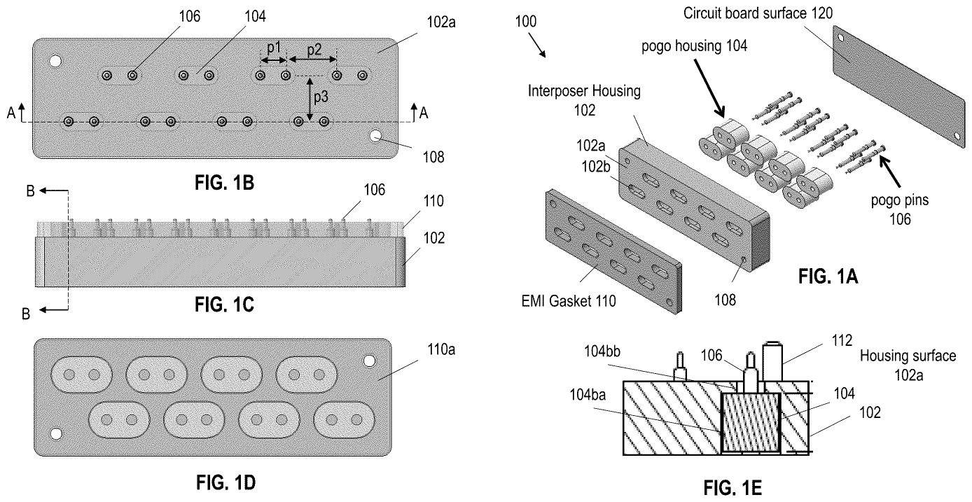

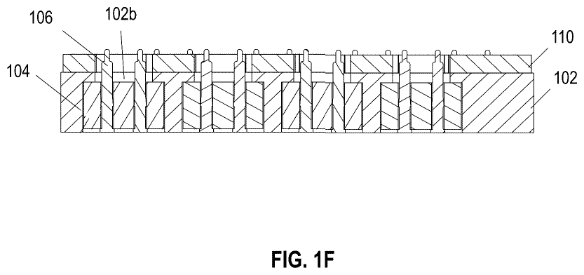

FIG. 1A illustrates an exploded view of an interposer according to some embodiments. FIG. 1B illustrates a top view of the interposer of FIG. 1A. FIG. 1C illustrates a side view of the interposer of FIG. 1A. FIG. 1D illustrates a bottom view of the interposer of FIG. 1A. FIG. 1E illustrates a cross-sectional view of the interposer of FIG. 1C. The cross-sectional view shown in FIG. 1E may be taken along B-B in FIG. 1C. FIG. 1F illustrates a cross-sectional view of the interposer of FIG. 1A. The side view shown in FIG. 1F may be taken along A-A in FIG. 1B.

Interposers include conductive pathways through which electrical signals are transmitted between the connected components. Interposers can be implemented using various technologies such as spring probes, conductive traces, or through-silicon vias in more advanced designs. The interposer 100 shown in FIG. 1A includes an interposer housing 102, pogo pin housings 104, pogo pins 106, and a gasket 110.

The interposer housing 102 may be formed from a conductive material. For example, the interposer housing 102 may be formed from aluminum or copper or alloys, as well as being nickel or gold plated. The interposer housing 102 may have guide holes 108 formed in one or more corners of the interposer housing 102. The guide holes 108 may be used to align the gasket 110 and the interposer housing 102, and in some cases may be used to fix the gasket 110 to the interposer housing 102. The interposer housing 102 may provide structural support for the interposer 100 and provides shielding and grounding for differential signals traveling along the pogo pins 106. FIG. 1B shows a surface 102a of the interposer housing 102.

The interposer housing 102 may contain multiple vias 102b that extend through the interposer housing 102. The vias 102b may be formed in any shape, such as the stadium shape shown in FIGS. 1A, 1B, and 1D (opposing flat sides connected by a semicircle), or ovular or rounded rectangular shape having rounded corners but flat sides. The pogo pin housings 104 may be mechanically inserted into the vias 102b. The pogo pin housings 104 may be formed from non-conductive materials such as plastic or other non-conductive polymers. The pogo pin housings 104 may be used to insulate and support conductive elements (the pogo pins 106) disposed therein. The pogo pin housing material maintains signal integrity through the pogo pins 106 and controls impedance for the signals.

The pogo pins 106 are conductive elements disposed within the pogo pin housings 104. In this case, as a differential signal is used, a different pair of pogo pins 106 extend through each pogo pin housing 104. Each pair of pogo pins 106 carry a differential signal between the components on the opposing sides of the interposer 100. The pogo pins 106 are flexible elements that are able to provide compression to ensure reliable connections across varying board-to-board distances. Although sixteen pogo pins 106 are shown, the number of pogo pins 106, as well as the location of the pogo pins 106 may be dependent on the boards or other electronics that the pogo pins 106 provide coupling between. The pogo pins 106 may have a nickel and gold finish. The pogo pins 106 may be soldered on one side (i.e., to one of the boards) rather than being coupled via pressure. The pogo pins 106 may be single- or double-sided, with single-sided pogo pins being soldered or otherwise permanently attached (e.g., to the circuit board surface 120 shown in FIG. 1A). The pogo pin housings 104 (and thus pogo pins 106) may be disposed in parallel rows that each contain the same number of pogo pin housings 104 and are offset from each other to increase the impedance. The distances p1 and p2 within each row may be constant throughout the interposer 100, as well as p3, the distance between rows. Although four pogo pin housings 104 and two rows are shown, the number of pogo pin housings 104 and/or rows may be different.

In some embodiments, such as that shown in FIG. 1E, the vias 102b in the interposer housing 102 may decrease in size (stepwise—i.e., the vias 102b have a step-shape) so that the pogo pin housings 104 extend only partially through the interposer housing 102, with the pogo pins 106 extending completely through the interposer housing 102. As shown in FIG. 1E, the pogo pin housings 104 extend a vast majority of the way through the interposer housing 102 (e.g., about ⅞ of the way through) for stability and isolation. The larger size portion 102ba of the vias 102b may match the size of the pogo pin housing 104, allowing the pogo pin housing 104 to fit snugly into the larger size portion 102ba of the vias 102b (within about 1-2 mils), while the smaller size portion 102ba of the vias 102b may be significantly smaller than the size of the pogo pin housing 104 but larger than the pogo pins 106 (e.g., about twice as large). In other embodiments, the vias 102b in the interposer housing 102 may extend entirely through the pogo pin housing 104 and have the same size throughout so that the pogo pin housing 104 extends completely through the interposer housing 102. Guide pins 112 are disposed in the guide holes 108 to align the interposer housing 102 and gasket 110.

Differential signals are electrical signals that are transmitted using two complementary voltage levels. Instead of sending a single signal over one wire, differential signaling uses two conductive paths to send the same signal in opposite phases, i.e., when one conductive path carries a high voltage, the other conductive path carries a low voltage (or a positive voltage and negative voltage), thereby using the voltage difference between the two conductive path rather than the absolute voltage levels. A differential receiver measures this voltage difference to determine the transmitted signal. Differential signals reduce noise and electromagnetic interference (EMI) because any external noise tends to affect both conductive paths equally, canceling out when the difference is calculated. Accordingly, differential signals maintain signal integrity over longer distances and at higher frequencies, making them better for high-speed data transmission than individual signals. Additionally, the close proximity of the two wires helps reduce crosstalk from adjacent signal lines. Differential signaling is used communication standards such as Universal Signal Bus (USB), Ethernet, and High-Definition Multimedia Interface (HDMI) and high-speed interfaces such as Peripheral Component Interconnect (PCI) Express to achieve high data rates, and RF applications to improve signal integrity and reduce interference.

The gasket 110 may provide a shield against electromagnetic interference (EMI) introduced by the Printed Circuit Board (PCB), not shown, or other circuit to which the pogo pins 106 are coupled. The gasket 110 may be formed from an elastomeric material that may have conductive particles embedded therein (or from a conductive material) and may be disposed between the interposer housing 102 and the PCB. The gasket 110 may have openings that have the same size, shape, and location as those in the interposer housing 102. The openings in the gasket 110 may accept the pogo pin housings 104 (and pogo pins 106). In some embodiments, the gasket 110 may include grounding and shielding elements that can include pre-cut electrically conductive structures designed to provide continuous ground connections and improve isolation between signal paths. The gasket 110 is thus disposed on a surface of the interposer housing 102 and may provide a ground connection between the electronic components and provide a continuous ground around each pair of pogo pins 106. FIG. 1D shows a surface 110a of the gasket 110 shown in FIG. 1C.

In some embodiments, the gasket 110 may have openings that are smaller than those of the interposer housing 102 but otherwise have the same shape and location, allowing slight extensions from the gasket 110 to fit into the openings in the interposer housing 102 (e.g., the extensions extending ⅕- 1/20 of the total thickness into the openings in the interposer housing 102 thereby providing simple alignment when the outer surface of the extension is the same size in length and width as the pogo pin housings 104). In this latter embodiment, the pogo pin housings 104 may be smaller in thickness than the openings in the interposer housing 102 leaving a small (relative to the opening) lateral air gap between the pogo pins 106 and the openings in the gasket 110.

The gasket 110 in various embodiments may be a multi-layer structure. The layers of the gasket 110, for example, may include conductive pressure sensitive adhesive (PSA) layers surrounding a conductive polyurethane (PU) foam. The PU foam may be filled with conductive particles such as nickel. In other embodiments, a conductive fabric may be added between the PU foam and the PSA.

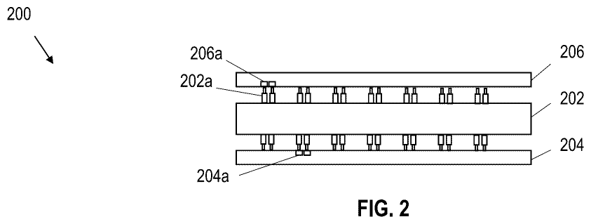

FIG. 2 illustrates a system according to some embodiments. The system 200 includes an interposer 202 disposed between electronic structures 204, 206 on opposing sides of the interposer 202. One embodiment of the interposer 202 is shown in more detail in FIGS. 1A-1D. The circuitry and signal traces 204a, 206a on the electronic structures 204, 206 are coupled together using pogo pins 202a that extend between the electronic structures 204, 206. The electronic structures 204, 206 may include one or more PCBs, modular RF personality boards (RFPBs), or other single or multi-layer structures that contain electronic components and signal traces disposed on and/or fabricated within the electronic structures 204, 206. In some embodiments, not all of the pogo pins 202a may be used. In some embodiments, the interposer 202 may include active elements for signal conditioning or routing, and in high-power applications, the interposer 202 may incorporate features (such as one or more fins) for heat dissipation.

The thickness of the interposer 202, as well as the material used to form the interposer 202, may be selected to provide impedance matching, and thus to maintain a specific impedance (e.g., 50 or 100 ohm differential impedance) across a wide frequency range to ensure optimal signal transmission. The interposer 202 may have dimensions designed to and/or incorporate features to minimize crosstalk between adjacent signal paths while still maintaining signal integrity. The interposer 202 may have a thickness and be formed from a material selected to maintain reliable electrical connections under various conditions, including thermal cycling and mechanical stress, as well as accommodate a high density of connections in a small area.

The interposer 202 is designed to interface with boards for high-frequency applications, e.g., up to 40 GHz. In some embodiments, the interposer 202 may have dimensions of about 0.972 inches in length, about 0.318 inches in width, and about 0.157 to about 0.170 inches in height when uncompressed. The interposer 202 may use a pre-cut adhesive-backed conductive gasket to ensure continuous grounding around differential pairs, enhancing isolation. The spacing between the centers of the pogo pins 202a may be about 0.048 inches (i.e., a 48 mil pitch is used), and the ground plane spacing may be increased to about 0.100 inches and conductor spacing to about 0.068 inches, achieving a good 100-ohm differential impedance over the frequency range of about 0 to about 40 GHz. Example distances shown in FIG. 1B include p1=pitch between adjacent pogo pins in a differential pair (about 0.048 inches), p2=distance between closest pogo pins in adjacent differential pairs (about 0.096 inches) in a row, and p3=distance between rows (about 0.063 inches). The pitch ensures proper alignment and connection between the interposer 202 and the electronic structures 204, 206. The pitch affects the density of connections and plays a role in maintaining signal integrity and impedance matching, especially in high-frequency applications. The pogo pin housings may be about 0.118 inches to about 0.131 inches in length (in the direction of the row) and about 0.051 inches in height (in the direction between rows). The conductive gasket material may have dimensions of about 0.10 mm×about 0.25 mm pitch x about 1.0 mm thick, which simplifies placement and improves impedance matching. The pogo pins 202a may be designed to provide electrical contact between a limited range, e.g., about 0.166 mil and about 0.174 mil for the examples described herein. The overall design permits a return loss of under about-10 dB over the entire range of frequencies DC to about 40 GHz, as well as about 100 ohm differential impedance over the same frequency range. In other embodiments, p1 may be about 0.068 inches, p2 may be about 0.136 inches, and p3 may be about 0.122 inches, and the pogo pin housings may be about 0.168 inches in length and about 0.1 inches in height.

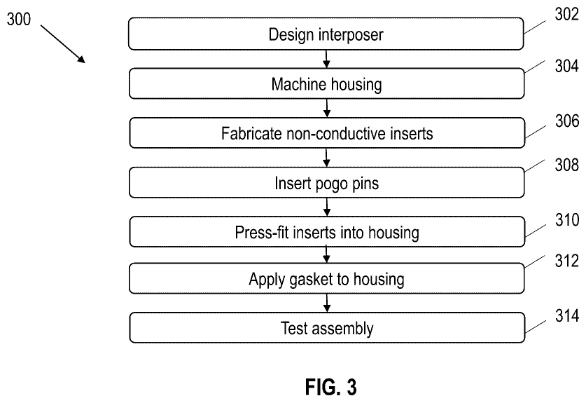

FIG. 3 shows a method of fabricating an interposer according to some embodiments. Only some of the operations are shown in the method 300 of FIG. 3; other operations may be present but are not shown. Similarly, not all of the operations shown in FIG. 3 may be present in the method 300. To fabricate the interposer, the process may begin with operation 302, in which the interposer layout is designed to meet the required dimensions for the application. Appropriate materials are selected, such as Al-Aly 6061 for the conductive housing and TecaPeek for the pogo pin housings. At operation 304 the conductive housing may be machined from the selected material, ensuring precise dimensions and the formation of guide holes for alignment, providing structural support and RF shielding. At operation 306 non-conductive inserts may be fabricated from materials like plastic or other polymers to house the pogo pins and maintain signal integrity. At operation 308 pogo pins may be inserted pins into the non-conductive inserts, ensuring that each pair of differential spring probes is correctly positioned to maintain electrical contact across varying board-to-board spacings. At operation 310 the non-conductive inserts with the pogo pins may be press-fit into the vias of the conductive housing, ensuring proper alignment and secure placement to maintain signal integrity and impedance control. At operation 312 a pre-cut adhesive-backed conductive gasket may be applied to the surface of the conductive housing to provide continuous grounding around the differential pairs and enhance isolation. At operation 314 the components may be assembled and tested to ensure that the conductive gasket and pogo pins are correctly aligned, and test the interposer for electrical performance, focusing on impedance matching and EMI shielding effectiveness. This ensures that the interposer is fabricated to meet high-frequency application requirements, providing reliable connections and effective isolation.

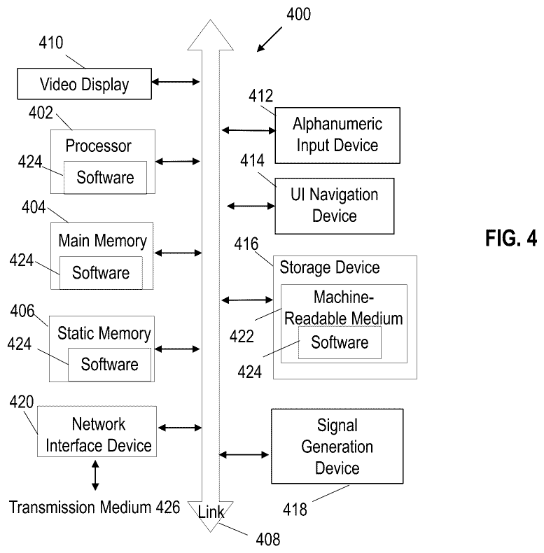

FIG. 4 illustrates a block diagram of an electronic device in accordance with some aspects. The electronic device 400 may be a device using the interposer described in the above figures and at least some of whose components may be coupled using the interposer as shown in FIG. 2. The electronic device 400 may be capable of executing instructions (sequential or otherwise) that specify actions to be taken by that device. Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The electronic device 400 may include a hardware processor (or equivalently processing circuitry) 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The main memory 404 may contain any or all of removable storage and non-removable storage, volatile memory or non-volatile memory. The electronic device 400 may further include a display unit 410 such as a video display, an alphanumeric input device 412 (e.g., a keyboard), and a user interface (UI) navigation device 414 (e.g., a mouse). In an example, the display unit 410, input device 412 and UI navigation device 414 may be a touch screen display. The electronic device 400 may additionally include a storage device (e.g., drive unit) 416, a signal generation device 418 (e.g., a speaker), a network interface device 420, and one or more sensors, such as a global positioning system (GPS) sensor, compass, accelerometer, or another sensor. The electronic device 400 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a non-transitory machine readable medium 422 (hereinafter simply referred to as machine readable medium) on which is stored one or more sets of data structures or instructions 424 (e.g., software) embodying or utilized by any one or more of the techniques or functions described herein. The non-transitory machine readable medium 422 is a tangible medium. The instructions 424 may also reside, completely or at least partially, within the main memory 404, within static memory 406, and/or within the hardware processor 402 during execution thereof by the electronic device 400. While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the electronic device 400 and that cause the electronic device 400 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 424 may further be transmitted or received over a communications network using a transmission medium 426 via the network interface device 420 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), IEEE 802.11 family of standards, and wireless data networks. In an example, the network interface device 420 may include one or more physical jacks (e.g., Ethernet, coaxial, or phone jacks) or one or more antennas to connect to the transmission medium 426.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a GSM radio communication technology, a GPRS radio communication technology, an Enhanced Data Rates for GSM Evolution (EDGE) radio communication technology, and/or a Third Generation Partnership Project (3GPP) radio communication technology.

### EXAMPLES

Example 1 is an interposer for connection between electronic components, comprising: a conductive housing containing vias; a plurality of non-conductive inserts disposed within the vias of the conductive housing; a plurality of pairs of differential spring probes, each pair of spring probes disposed within one of the non-conductive inserts; and a conductive gasket disposed on a surface of the conductive housing, the conductive gasket configured to provide a ground connection between the electronic components and provide a continuous ground around the pairs of spring probes.

In Example 2, the subject matter of Example 1 includes, wherein each pair of spring probes are disposed in a different non-conductive insert.

In Example 3, the subject matter of Example 2 includes, wherein none of the pairs of differential spring probes are used for grounding.

In Example 4, the subject matter of Examples 2-3 includes, wherein each non-conductive insert has a stadium shape.

In Example 5, the subject matter of Examples 2-4 includes, wherein each via has a step-shape in which a larger size portion of the via matches a size of a corresponding non-conductive insert disposed within via, while a smaller size portion of the via is smaller than the size of the corresponding non-conductive insert but larger than the pair of spring probes in the corresponding non-conductive insert.

In Example 6, the subject matter of Example 5 includes, wherein the conductive gasket comprises holes, each hole corresponding to a different non-conductive insert and configured to receive a different pair of spring probes to provide an air dielectric between the pairs of spring probes and the conductive gasket.

In Example 7, the subject matter of Example 6 includes, wherein the conductive gasket comprises a conductive pressure sensitive adhesive layer and a conductive polyurethane foam layer that contains conductive particles, and is attached to the conductive housing via an adhesive layer.

In Example 8, the subject matter of Examples 5-7 includes, wherein the non-conductive inserts are disposed in multiple rows within the conductive housing, the pairs of spring probes in each row of non-conductive inserts configured to avoid overlap in a columnar direction with the pairs of spring probes in an adjacent row of non-conductive inserts.

In Example 9, the subject matter of Example 8 includes, wherein a distance between the non-conductive in each row of non-conductive inserts is larger than a distance between the pairs of spring probes in each row of non-conductive inserts, the pairs of spring probes in each row of non-conductive inserts disposed in an area between the non-conductive inserts in an adjacent row of non-conductive inserts.

In Example 10, the subject matter of Example 9 includes, wherein the pairs of spring probes are configured to provide electrical contact across a range of board-to-board spacings from about 0.166 inches to about 0.174 inches, and the interposer is configured to operate at frequencies of up to about 40 GHz.

Example 11 is a high-frequency signal differential transmission system, comprising: electronic components separated by an interposer, the interposer comprising: a conductive housing containing vias; a plurality of non-conductive inserts disposed within the conductive housing; a plurality of pairs of differential spring probes, each pair of spring probes disposed within one of the non-conductive inserts and configured to couple differential signals between the electronic components at frequencies from 0 GHz up to at least about 40 GHz; and a conductive gasket disposed on a surface of the conductive housing, the conductive gasket configured to provide a ground connection between the electronic components and provide a continuous ground around the pairs of spring probes.

In Example 12, the subject matter of Example 11 includes, wherein each via has a step-shape in which a larger size portion of the via matches a size of a corresponding non-conductive insert disposed within via, while a smaller size portion of the via is smaller than the size of the corresponding non-conductive insert but larger than the pair of spring probes in the corresponding non-conductive insert.

In Example 13, the subject matter of Example 12 includes, wherein the conductive gasket comprises holes, each hole corresponding to a different non-conductive insert and configured to receive a different pair of spring probes to provide an air dielectric between the pairs of spring probes and the conductive gasket.

In Example 14, the subject matter of Example 13 includes, wherein the conductive gasket comprises a conductive pressure sensitive adhesive layer and a conductive polyurethane foam layer that contains conductive particles, and is attached to the conductive housing via an adhesive layer.

In Example 15, the subject matter of Example 14 includes, wherein the non-conductive inserts are disposed in multiple rows within the conductive housing, the pairs of spring probes in each row of non-conductive inserts configured to avoid overlap in a columnar direction with the pairs of spring probes in an adjacent row of non-conductive inserts.

In Example 16, the subject matter of Example 15 includes, wherein a distance between the non-conductive in each row of non-conductive inserts is larger than a distance between the pairs of spring probes in each row of non-conductive inserts, the pairs of spring probes in each row of non-conductive inserts disposed in an area between the non-conductive inserts in an adjacent row of non-conductive inserts.

In Example 17, the subject matter of Example 16 includes, wherein none of the pairs of differential spring probes are used for grounding.

In Example 18, the subject matter of Example 17 includes, wherein: the differential spring probes are single-ended spring probes, and the first electronic components is a modular RF personality board (RFPB) that is coupled to the differential spring probes via a permanent connection.

Example 19 is a method of manufacturing an interposer to connect electronic components, comprising: forming a conductive housing; positioning non-conductive inserts within the conductive housing; inserting pairs of differential spring probes into the non-conductive inserts; and applying a conductive gasket to a surface of the conductive housing to provide a ground connection between the electronic components.

In Example 20, the subject matter of Example 19 includes, press-fitting the non-conductive inserts with the differential spring probes into the conductive housing.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although embodiments have been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. For example, the term “a processor” configured to carry out specific operations includes both a single processor configured to carry out all of the operations as well as multiple processors individually configured to carry out some or all of the operations (which may overlap) such that the combination of processors carry out all of the operations. Note that the term “about x” and similar terms (e.g., substantially) as used herein may be understood to be within 10% of x or otherwise within a range known to one of skill in the art to be within tolerance of the quantity or quality described unless indicated otherwise.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, the subject matter lies in less than all features of a single disclosed embodiment. Thus, the following claims are hereby incorporated into the Detailed Description, with each claim standing on its own as a separate embodiment.

1. An interposer for connection between electronic components, comprising:
a conductive housing containing vias;
a plurality of non-conductive inserts disposed within the vias of the conductive housing;
a plurality of pairs of differential spring probes, each pair of spring probes disposed within one of the non-conductive inserts; and
a conductive gasket disposed on a surface of the conductive housing, the conductive gasket configured to provide a ground connection between the electronic components and provide a continuous ground around the pairs of spring probes.

2. The interposer of claim 1, wherein each pair of spring probes are disposed in a different non-conductive insert.

3. The interposer of claim 2, wherein none of the pairs of differential spring probes are used for grounding.

4. The interposer of claim 2, wherein each non-conductive insert has a stadium shape.

5. The interposer of claim 2, wherein each via has a step-shape in which a larger size portion of the via matches a size of a corresponding non-conductive insert disposed within via, while a smaller size portion of the via is smaller than the size of the corresponding non-conductive insert but larger than the pair of spring probes in the corresponding non-conductive insert.

6. The interposer of claim 5, wherein the conductive gasket comprises holes, each hole corresponding to a different non-conductive insert and configured to receive a different pair of spring probes to provide an air dielectric between the pairs of spring probes and the conductive gasket.

7. The interposer of claim 6, wherein the conductive gasket comprises a conductive pressure sensitive adhesive layer and a conductive polyurethane foam layer that contains conductive particles, and is attached to the conductive housing via an adhesive layer.

8. The interposer of claim 5, wherein the non-conductive inserts are disposed in multiple rows within the conductive housing, the pairs of spring probes in each row of non-conductive inserts configured to avoid overlap in a columnar direction with the pairs of spring probes in an adjacent row of non-conductive inserts.

9. The interposer of claim 8, wherein a distance between the non-conductive in each row of non-conductive inserts is larger than a distance between the pairs of spring probes in each row of non-conductive inserts, the pairs of spring probes in each row of non-conductive inserts disposed in an area between the non-conductive inserts in an adjacent row of non-conductive inserts.

10. The interposer of claim 9, wherein the pairs of spring probes are configured to provide electrical contact across a range of board-to-board spacings from about 0.166 inches to about 0.174 inches, and the interposer is configured to operate at frequencies of up to about 40 GHz.

11. A high-frequency signal differential transmission system, comprising:
electronic components separated by an interposer, the interposer comprising:
a conductive housing containing vias;
a plurality of non-conductive inserts disposed within the conductive housing;
a plurality of pairs of differential spring probes, each pair of spring probes disposed within one of the non-conductive inserts and configured to couple differential signals between the electronic components at frequencies from 0 GHz up to at least about 40 GHz; and
a conductive gasket disposed on a surface of the conductive housing, the conductive gasket configured to provide a ground connection between the electronic components and provide a continuous ground around the pairs of spring probes.

12. The system of claim 11, wherein each via has a step-shape in which a larger size portion of the via matches a size of a corresponding non-conductive insert disposed within via, while a smaller size portion of the via is smaller than the size of the corresponding non-conductive insert but larger than the pair of spring probes in the corresponding non-conductive insert.

13. The system of claim 12, wherein the conductive gasket comprises holes, each hole corresponding to a different non-conductive insert and configured to receive a different pair of spring probes to provide an air dielectric between the pairs of spring probes and the conductive gasket.

14. The system of claim 13, wherein the conductive gasket comprises a conductive pressure sensitive adhesive layer and a conductive polyurethane foam layer that contains conductive particles, and is attached to the conductive housing via an adhesive layer.

15. The system of claim 14, wherein the non-conductive inserts are disposed in multiple rows within the conductive housing, the pairs of spring probes in each row of non-conductive inserts configured to avoid overlap in a columnar direction with the pairs of spring probes in an adjacent row of non-conductive inserts.

16. The system of claim 15, wherein a distance between the non-conductive in each row of non-conductive inserts is larger than a distance between the pairs of spring probes in each row of non-conductive inserts, the pairs of spring probes in each row of non-conductive inserts disposed in an area between the non-conductive inserts in an adjacent row of non-conductive inserts.

17. The system of claim 16, wherein none of the pairs of differential spring probes are used for grounding.

18. The system of claim 17, wherein:
the differential spring probes are single-ended spring probes, and
a first of the electronic components is a modular RF personality board (RFPB) that is coupled to the differential spring probes via a permanent connection.

19. A method of manufacturing an interposer to connect electronic components, comprising:
forming a conductive housing;
positioning non-conductive inserts within the conductive housing;
inserting pairs of differential spring probes into the non-conductive inserts; and
applying a conductive gasket to a surface of the conductive housing to provide a ground connection between the electronic components.

20. The method of claim 19, further comprising press-fitting the non-conductive inserts with the differential spring probes into the conductive housing.
